(19) United States
(12) Patent Application Publication
(10) Pub. No.: US 2007/0258478 A1
(43) Pub. Date: Nov. 8, 2007

(54) Methods and/or apparatus for link optimization

(75) Inventors: Ephrem C. Wu, San Mateo, CA (US); Anthony C. Sweeney, San Francisco, CA (US)

Correspondence Address: LSI CORPORATION, 1621 BARBER LANE, MS: D-106, MILPITAS, CA, 95035, US

(73) Assignee: LSI LOGIC CORPORATION

(21) Appl. No.: 11/418,702

(22) Filed: May 5, 2006

(51) Int. Cl. H04J 3/16

(52) U.S. Cl. 370/437

(57) ABSTRACT

An apparatus comprising at least two controllers and one or more links. Each controller may be configured to control one or more transmitters and one or more receivers in response to a control state signal. The one or more links may be configured to allow communication between the controllers to automatically perform characterization of the one or more links with a link packet protocol.

### FIELD OF THE INVENTION

The present invention relates to communication networks generally and, more particularly, to a method and/or apparatus for link optimization.

### BACKGROUND OF THE INVENTION

Conventional high-speed serial transceivers include many programmable parameters. These programmable parameters enable a high speed serial transceiver to transmit and receive symbols with sufficient margin at multiple gigabits per second across a link. Optimizing a link to gain sufficient margin needs information related to knowledge on how and by how much the link distorts symbols. In a transmitter that transmits a sequence of five logic-one symbols followed by two logic-zero symbols across a link, the receiver interprets six logic-one symbols and one logic-zero symbol, resulting in one bit error.

Link characterization is used to reveal to what extent and how a link distorts symbols, information that enables minimization of such distortion. A link between a transmitter and a receiver via a printed-circuit board (PCB) trace and cables appears as a low-pass filter to the transmitter due to (i) skin effect from strip guides, (ii) cable losses, and (iii) dielectric absorption from printed circuit board materials. The link reduces the high-frequency components of symbols traveling, which causes a receiver to misinterpret symbols, resulting in bit errors. To prevent bit errors due to the low-pass filtering effect, a transmitter employs a pre-emphasis filter to boost the high-frequency components of the symbols that are transmitted by the transmitter. The pre-emphasis filter has parameters to enable the transfer function of the pre-emphasis to closely match the inverse of the low-pass filter over the link.

System software typically performs link characterization. System software is a time-consuming process since system software designers must familiarize themselves with low-level control and status interfaces of the high-speed transceivers.

It would be desirable to implement a method and/or apparatus which implements transceivers across multiple links to negotiate parameters automatically and to optimize signal integrity with minimal system software intervention.

### SUMMARY OF THE INVENTION

The present invention concerns an apparatus comprising at least two controllers and one or more links. Each controller may be configured to control one or more transmitters and one or more receivers in response to a control state signal. The one or more links may be configured to allow communication between the controllers to automatically perform characterization of the one or more links with a link packet protocol.

The objects, features and advantages of the present invention include providing a method and/or apparatus for link optimization that may (i) alleviate system software load, (ii) fine-tune optimization parameters among a number of high-speed transceivers and/or (iii) be easy to implement.

### BRIEF DESCRIPTION OF THE DRAWINGS

These and other objects, features and advantages of the present invention will be apparent from the following detailed description and the appended claims and drawings in which:

FIG. 1 illustrates a bidirectional differential serial link to be optimized in accordance with the present invention;

FIG. 2 illustrates characters used in an exemplary link optimization protocol as waveforms in accordance with the present invention;

FIG. 3 illustrates an exemplary circuit that implements the link optimization protocol for a receiver system in accordance with the present invention;

FIG. 4 illustrates an example of bit alignment for the link optimization protocol in accordance with the present invention;

FIG. 5 illustrates an exemplary bit-alignment state machine in accordance with the present invention;

FIG. 6 illustrates an exemplary circuit that implements the link optimization protocol for a transmitter system in accordance with the present invention; and

FIG. 7 illustrates an exemplary application-specific integrated circuit with multiple transceivers sharing one embedded controller in accordance with the present invention.

### DETAILED DESCRIPTION OF THE PREFERRED EMBODIMENTS

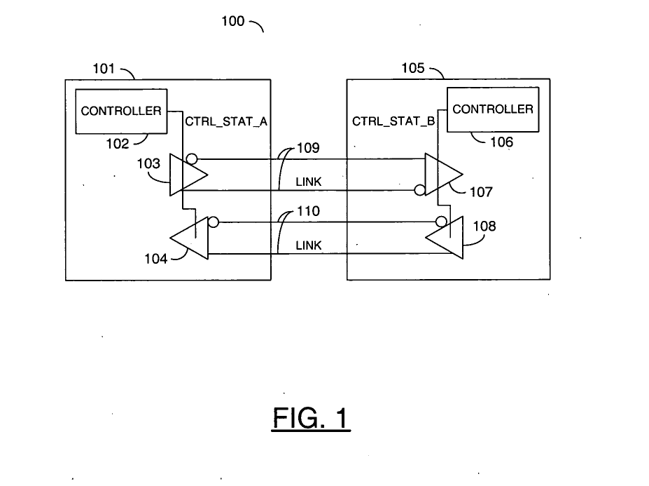

Referring to FIG. 1, a block diagram of a system 100 is shown in accordance with a preferred embodiment of the present invention. The system 100 generally comprises a block (or circuit) 101 and a block (or circuit) 105. The circuit 101 may be implemented as an integrated circuit. The circuit 105 may be implemented as an integrated circuit. The integrated circuit 101 may present a link 109 to the integrated circuit 105. The integrated circuit 105 may present a link 110 to the integrated circuit 101. The circuit 101 generally comprises a block (or circuit) 102, a block (or circuit) 103, and a block (or circuit) 104. The circuit 102 may be implemented as an embedded controller. The embedded controller 102 may be implemented as a master controller. The embedded controller 106 may be implemented as a slave controller. The circuit 103 may be implemented as a transmitter. The circuit 104 may be implemented as a receiver. The embedded controller 102 may present a control status signal (e.g., CTRL_STAT_A) to the transmitter 103 and to the receiver 104.

The circuit 105 generally comprises a block (or circuit) 106, a block (or circuit) 107, and a block (or circuit) 108. The circuit 106 may be implemented as an embedded controller. The circuit 107 may be implemented as a receiver. The circuit 108 may be implemented as a transmitter. The embedded controller 106 may present a control status signal (e.g., CTRL_STAT_B) to the receiver 107 and to the transmitter 108.

The transmitters 103 and 108 may include link optimization parameters. The receivers 104 and 107 may include link optimization parameters. The link optimization parameters may include optimal pre-emphasis filter coefficients (or pre-emphasis parameters), first decision feedback equalization parameters and second decision feedback equalization parameters. For the link 109 or the link 110, the link optimization parameters in the transmitters 103 and 108 and the receivers 104 and 107 may be tuned to check the quality (or sufficiency) of the link optimization parameters. The system 100 may select the best set of link optimization parameters to use for data transmission. The system 100 characterizes the link 109 and 110 by selecting the best set of link optimization parameters. The link optimization parameters may indicate the extent to which the link 109 or 110 may distort signals. The link optimization parameters may negate distortion over the links 109 and 110 by building filters (not shown) in the transmitters 103 and 108 or in the receivers 104 and 107.

The transmitters 103 and 108 may each include the optimal pre-emphasis filter coefficient. The optimal pre-emphasis filter coefficients may boost high-frequency components in signals to overcome high-frequency attenuation by a signal path (e.g., a printed circuit board trace). The first decision feedback equalization parameter in the receiver 104 or 107 may form a first adaptive filter (not shown) to recover signals in the presence of cross talk. The second decision feedback equalization parameters in the transmitters 103 and 108 and the receivers 104 and 107 may each form a second adaptive filter between the links 109 and 110. The second adaptive filter may recover signals in the presence of cross talk.

The system 100 may be characterized by determining optimal pre-emphasis filter coefficients of the transmitter 103 using the embedded controller 102 and the embedded controller 106. Each embedded controller may control and query all transmitters and receivers in the same integrated circuit. For example, the embedded controller 102 may control and query the transmitter 103 and receiver 104 via the signal CTRL_STAT_A or the integrated circuit 101. Similarly, the embedded controller 106 may control and query the transmitter 108 and the receiver 107 via the signal CTRL_STAT_B on the integrated circuit 105. In addition, the embedded controller 102 and the embedded controller 106 may communicate with each other in-band via the links 109 and 110. The link 109 and the link 110 may be defined as a physical connection between a transmitter and a receiver. A link may be implemented as (i) a single wire between a transmitter and receiver in single-ended signaling, (ii) a pair of wires in differential signaling, (iii) free space in laser communication, and/or (iv) line of sight in wireless communication. In general, an extra communication link is not needed between the integrated circuits 101 and 105. With such a bidirectional in-band communication link, one embedded controller may be the master to control and query all transmitters and receivers in both integrated circuits. For example, the embedded controller 102 may be implemented as the master controller.

The system 100 may provide a number of methods for measuring the goodness (or sufficiency) of the link optimization parameters. In one example, the master controller 102 may determine the optimal pre-emphasis filter coefficients for the transmitter 108 with a pseudo-random bit stream (PRBS) to generate a bit pattern to test for bit errors. The master controller 102 may determine optimal pre-emphasis filter coefficients for the transmitter 108 at a line rate of 2.5 Gbps (or at any predetermined line-rate) by performing the following:

(i) the master controller 102 may control the transmitter 103 with the signal CTRL_STAT_A to send at a low data rate over the link 109 to the slave controller 106 (e.g., via the receiver 107 and the signal CTRL_STAT_B) a command C₁, to control the transmitter 108 to (a) run at 2.5 Gbps using a pre-emphasis filter coefficient set (e.g., P) and (b) generate a pseudo-random bit stream (PRBS) based on the polynomial x²³+x¹⁸+1;

(ii) the slave controller 106 may relay the command C₁ via the signal CTRL_STAT_B to the transmitter 108;

(iii) the master controller 102 may (a) set the receiver 104 to run at 2.5 Gbps and (b) start counting PRBS bit errors based on the same polynomial x²³+x¹⁸+1 for the next hour with the signal CTRL_STAT_A;

(iv) after an hour, the master controller 102 may query the receiver 104 with the signal CTRL_STAT_A for a bit error count;

(v) the receiver 104 may present the bit error count with the signal CTRL_STAT_A in response to receiving the query from the master controller 102; and

(vi) the above process may be repeated for different values of P (e.g., different pre-emphasis filter coefficient sets). The set that creates the least amount of bit errors may be the optimal set.

A predetermined bitstream may be generated to test (i) for bit errors and (ii) the quality of the links 109 and 110. The transmitters 103 and 108 may generate and transmit the predetermined bitstream to the receivers 104 and 107. The system 100 may not need expensive hardware to generate to the predetermined bitstream. The predetermined bitstream may include data signals. The data signals may include a wide spectrum of frequency components. In one example, a predetermined bitstream may include alternating ones and zeros followed by a number of zeros and further followed by a one. The predetermined bitstream may be generated according to IEEE 802.3ae Continuous Jitter Pattern (CJPAT) and Continuous Random Pattern (CRPAT) (or IEEE standard). The IEEE standard may define standard bitstreams for ethernet. The predetermined bitstream may be implemented as the pseudo-random bitstream.

Additional methods may be implemented to test link quality. In one example, the controller 102 may query the receiver 104 to assess the signal quality seen by the receiver 104. The receiver 104 may be measured to assess signal voltage amplitude (or measure the signal eye height in the receiver 104) after receiver equalization. The receivers 104 and 107 may each optionally include a receiver equalizer (not shown). The receiver equalizer may increase high-frequency components of the data signals received by the receivers 104 and 107. The higher the amplitude (e.g., mean, medium, or some other statistical criterion), the better the link optimization parameters. In one example, signal jitter may be measured (or eye width may be measured). In general, the less the jitter, the greater the width of signal eye. As the width of the signal eye increases, the better the link optimization parameters.

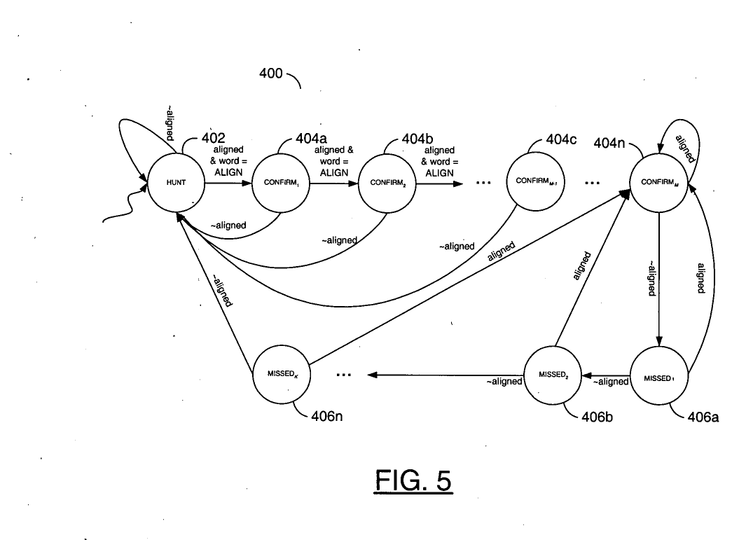

A simple, robust and flexible communication protocol at a sufficiently low bit rate may be implemented to allow the transmitters 103 and 108 to communicate commands and responses reliably across the links 109 and 110. The links 109 and 110 may be unoptimized when implementing a communication protocol (or a link packet protocol). To enable low-speed embedded controllers 102 and 106 to communicate across the high-speed differential serial links 109 and 110, the link packet protocol may comprise various repeated characters and multiple repeated characters which form commands or responses. The master controller 102 and the slave controller 106 may operate at a substantially lower rate than the bit rate across the links 109 and 110. In one example, the master controller 102 and the slave controller 106 may operate at a substantially lower rate than a maximum targeted bit rate across the links 109 and 110. The master controller 102 may repeat sending the same character until the master controller 102 receives an acknowledgement from the slave controller 106. A set of characters may be defined for the link packet protocol. The character names and corresponding symbols followed by binary representations are shown:
ALIGN or ‘@’: 00000111 11000111;
DOT or ‘.’ 11111111 00000000;
DASH or ‘-’: 00000000 11111111; and
ERROR or ‘!’: 11111000 11111000 00000111 00000111.
   The link packet protocol (or communication protocol) will be discussed in more detail in connection with FIG. 5.

The integrated circuit 101 may include additional transmitters and receivers connected to the signal CTRL_STAT_A. The integrated circuit 105 may include additional transmitters and receivers connected to the signal CTRL_STAT_B. The controller 102 may control and/or query one or more receivers and/or one or more transmitters via the control-state signal CTRL_STAT_A. The controller 106 may control and/or query one or more receivers and/or one or more transmitters via the control-state signal CTRL_STAT_B. When the controller 102 is configured by system software as the master controller, the controller 102 may control and/or query (i) one or more receivers (e.g., on the integrated circuit 105) and/or (ii) transmitters (e.g., on the integrated circuit 105) across the link 109. Each parameter in a receiver or a transmitter may be memory-mapped to one or more controllers (or the controllers 102 and 105). The signal CTRL_STAT_A or CRTL_STAT_B may include a memory address and a data portion. The following TABLE 1 illustrates a memory address that may comprise eight bits (e.g., ADDR[7:0]):

TABLE 1

| Address Bit Field | Description |
|---|---|
| ADDR[7:6] | Circuit type |
| ADDR[5:3] | Transmitter or receiver |
| | identification number |
| ADDR[2:0] | Register |

The most-significant two bits, or ADDR[7:6], may be the circuit-type field indicating whether the address belongs to a transmitter or a receiver. The remaining six bits, or ADDR[5:0], may refer to the register of a receiver or transmitter. TABLE 2 illustrates a two-bit circuit-type field ADDR[7:6]:

TABLE 2

| Circuit Type ADDR[7:6] | Description |
|---|---|
| 00 | Reserved |
| 01 | Reserved |
| 10 | Receiver |
| 11 | Transmitter |

The two-bit circuit-type field ADDR[7:6] may be encoded such that (i) the binary values “00” and “01” may be reserved, (ii) the binary value “10” may refer to a receiver, and (iii) the binary value “11” may refer to a transmitter. To control the receivers (e.g., the receiver 104 and the receiver 107) or the transmitters (e.g., the transmitter 103 and the transmitter 108), a controller may write a parameter value to the memory address corresponding to the parameter of the receiver or the transmitter. TABLE 3 illustrates an exemplary receiver register memory map:

TABLE 3

| Receiver Register | | |
|---|---|---|
| (ADDR[2:0] when | | |
| ADDR[7:6] = “10”) | Description | Encoding |
| 001 | Bit rate (BIT_RATE) | 00000000: 8× reference |
| | | clock rate |
| | | 00000001: 10× reference |
| | | clock rate |
| | | 00000010: 16× reference |
| | | clock rate |
| | | 00000011: 20× reference |
| | | clock rate |
| | | Otherwise: Undefined |
| 010 | Count PRBS bit errors | 00000000: Reset bit |
| | according to the | error count |
| | polynomial x²³ + x¹⁸ + 1 | 00000001: Start couting |
| | (PRBS23CTRL) | 00000010: Stop counting |
| 011 | PRBS23 bit error count | Binary |
| | bits 0 to 7. | |
| | (PRBS23CNT0) | |
| 100 | PRBS23 bit error count | Binary |
| | bits 8 to 15. | |
| | (PRBS23CNT1) | |
| 101 | PRBS23 bit error count | Binary |
| | bits 16 to 23. | |
| | (PRBS23CNT2) | |
| 110 | PRBS23 bit error count | Binary |
| | bits 24 to 31. | |
| | (PRBS23CNT3) | |
| 111 | PRBS23 bit error count | 00000000: Error count |
| | validity | invalid |
| | | 00000001: Error count |
| | | valid |

TABLE 4 illustrates an exemplary transmitter register memory map:

TABLE 4

| Transmitter Register | | |
|---|---|---|
| (ADDR[2:0] when | | |
| ADDR[7:6] = “11”) | Description | Encoding |
| 001 | Bit rate | 00000000: 8× reference |
| | (BIT RATE) | clock rate |
| | | 00000001: 10× reference |
| | | clock rate |
| | | 00000010: 16× reference |
| | | clock rate |
| | | 00000011: 20× reference |
| | | clock rate |
| | | Otherwise: Undefined |
| 010 | Generate PRBS | 00000000: Disable |
| | according to | 00000001: Enable |
| | the polynomial | |
| | x²³ + x¹⁸ + 1 | |
| 010 | Transmitter | Binary |
| | pre-emphasis | |
| | parameter | |

To command the transmitter with an identification number 2 to run at 2.5 Gbps when the reference clock operates at 250 MHZ, the controller may write the byte “00000001” to the address “11 010 001”. The byte “00000001” may correspond to setting the data rate at ten times the reference clock frequency.

To control receivers 104 and 107 and/or transmitters 103 and 108 across links 109 and 110, the controller 102 may encapsulate memory-mapped read/write commands in the payload portion of a packet according to the link packet protocol. The slave controller 106 may (i) capture the packets, (ii) extract the payload, and (iii) translate the memory-mapped read/write commands into receiver/transmitter register read/write commands within the signal CTRL_STAT_B. To respond to the master controller 102, the slave controller 106 may encapsulate response messages in the payload portion of packets as defined by the link packet protocol.

In general, the controller 102 may communicate to the transmitter 103 and the receiver 104 (or additional transmitters and/or receivers not shown that may be positioned within the integrated circuit 101) via the signal CTRL_STAT_A. When the controller 102 communicates with the transmitter 108 and the receiver (or additional transmitters and/or receivers within the integrated circuit 105), the controller 102 may embed the necessary read/write command inside a packet. The packet may be defined by the link packet protocol. The controller 102 may send the packet across the link 109. The controller 106 may (i) unpack the packet, (ii) extract the payload, (iii) execute the transceiver read/write command and (iv) echo the same packet back to the integrated circuit 101 to acknowledge receipt of the packet. The commands may be used to control and query the transmitters 103 or 108 and the receivers 104 or 107. The commands may be encapsulated in packets to allow for fault tolerance and protocol extensibility.

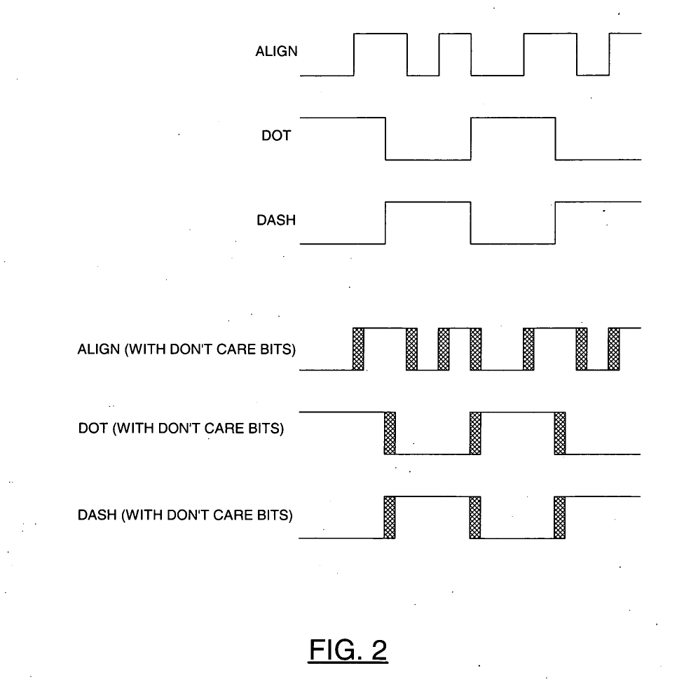

Referring to FIG. 2, a diagram illustrating characters as waveforms in accordance with the present invention is shown. The characters ALIGN, DOT, DASH and ERROR may be DC-balanced (e.g., there may be equal amounts of ones and zeros in each character). The links 109 and 110 may be AC-coupled (e.g., blocking capacitors may be implemented in the middle of the links 109 or 110). Unbalanced DC signals may induce common node voltage drifts in the signals. Such voltage drifts in the signal may make link characterization/optimization difficult. The links 109 and 110 may be unoptimized. When the characters ALIGN, DOT, DASH and ERROR are transmitted over the links 109 and 110 at a low bit rate. The character ALIGN may have a period of 16 bit cycles and may facilitate bit alignment. The character DOT and the character DASH may be square waves of 16 bit cycles with a 50% duty cycle. The character DOT and the character DASH may be 180 degrees out of phase from one another. The character DOT may represent a logic-1. The character DASH may represent a logic-0. Strings of the character DOT and the character DASH may form a binary command or response. The character ERROR may have a period of 32 bit cycles and may indicate that the receiver 107 and the receiver 104 have lost bit alignment.

Suboptimal pre-emphasis filter coefficients may appear as a low-pass filter and with smeared transitions. In one example, the link 109 may include one low pass filter and the link 110 may include one low pass filter. Therefore, the characters ALIGN, DOT, DASH, and/or ERROR may tolerate bit errors with the bit after a transition being a don't-care. For example, the characters ALIGN, DOT, DASH and/or ERROR may be recognized as:
ALIGN or ‘@’: X0000X11 11X00X11,
DOT or ‘.’: X1111111 X0000000,
DASH or ‘-’: X0000000 X1111111, and
ERROR or ‘!’: 11111X00 X1111X00 00000X11 x0000X11
   where ‘X’ denotes a don't-care bit. The characters ALIGN, DOT, DASH and ERROR may tolerate a zero, positive one, and/or negative one-bit shift in the data stream. FIG. 2 illustrates the don't-care bits as shaded boxes. It may be unnecessary to recognize the ERROR character. The character ERROR may be designed so that the receiver 107 and the receiver 104 may not recognize the character ERROR as the characters ALIGN, DOT, or DASH.

The system 100 may communicate across a bidirectional link in-band using the characters ALIGN, DOT, DASH, and/or ERROR with the embedded controller 102 positioned on the integrated circuit 101 and the embedded controller 106 positioned on the integrated circuit 105. The master controller 102 may initiate in-band communication with the slave controller 106. The master controller 102 may send the characters on the link 109 by controlling the transmitter 103 via the signal CTRL_STAT_A. The master controller 102 may receive the characters from the link 110 by controlling the receiver 104 via the signal CTRL_STAT_A. The slave controller 106 may respond to commands sent by the master controller 102. The slave controller 106 may receive the characters from the link 109 through the receiver 107 via the signal CTRL_STAT_B. The slave controller 106 may send the characters on the link 110 with the transmitter 108 via the signal CTRL_STAT_B. The master controller 102 may continuously transmit the same characters across the link 109 until the slave controller 106 echoes receipt of the transmitted character via the link 110.

The bidirectional communication link (e.g., the links 109 and 110) may (i) establish bit alignment across the system 100 and (ii) enable the controller 102 and the controller 106 to operate below wire speed to capture the characters. The master controller 102 may initiate bit alignment across the link 109 and the link 110 by sending the bit-alignment character ALIGN. To establish that the slave controller 106 has successfully received the character ALIGN, the slave controller 106 may echo back the character ALIGN via the link 110. The slave controller 106 may not initiate bit alignment. The slave controller 106 generally must wait for the master controller 102 to establish bit alignment. Immediately after a reset, the master controller 102 initiates bit alignment with the character ALIGN. The slave controller 106 generally expects bit alignment after a reset. The slave controller 106 may command the transmitter 108 to continuously send the character ERROR across the link 110 until the receiver 107 has (i) received the character ALIGN and (ii) established bit alignment. Once bit alignment has been established, the slave controller 106 may command the transmitter 108 to echo the character ALIGN back to the master controller 102 via the link 110. By echoing the character ALIGN back to the master controller 102, the completion of bit alignment is signaled across the link 109 and the link 110.

The system 100 may implement a sample-and-hold method to determine whether the incoming waveform represents any of the characters ALIGN, DOT, DASH, and/or ERROR. The character ALIGN may enable bit alignment, the result of which may be used later to distinguish between the character DOT and the character DASH.

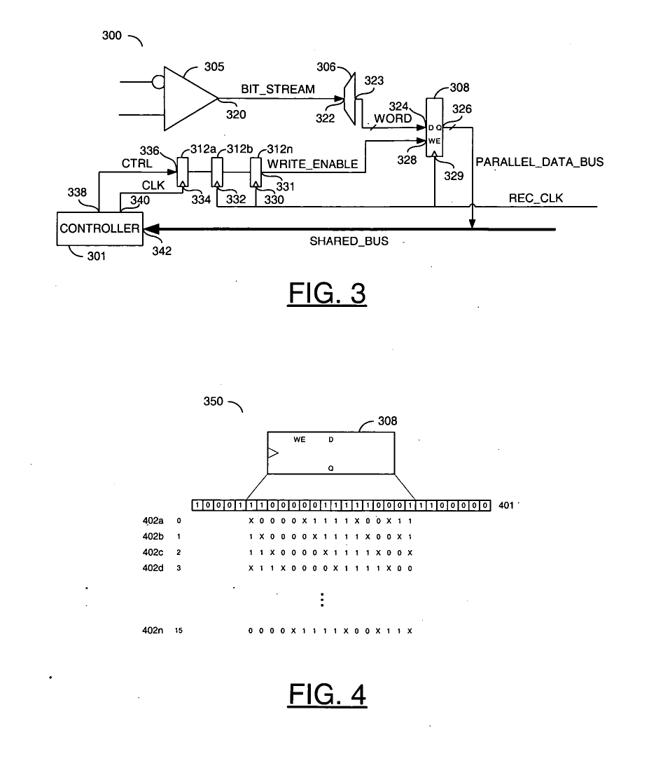

Referring to FIG. 3, a detailed diagram of a receiver system 300 in accordance with the present invention is shown. The receiver system 300 generally comprises a block (or circuit) 301, a block (or circuit) 305, a block (or circuit) 306, a block (or circuit) 308, and a number of blocks (or circuits) 312a-312n. The circuit 301 may be implemented as an embedded controller. The circuit 305 may be implemented as a high-speed receiver. The circuit 306 may be implemented as a deserializer. The circuit 308 may be implemented as a register. The circuits 312a-312n may be implemented as registers. The registers 312b and 312n may be implemented as a synchronizer.

The controller 301 may have an input 342 that may be connected to a bus (e.g., SHARED_BUS), an output 338 that may present a control signal (e.g., CTRL) and an output 340 that may present a signal (e.g. CLK). The receiver 305 may have an output 320 that may present a signal (e.g., BIT_STREAM). The deserializer 306 may have an input 322 that may receive the signal BIT_STREAM and an output 323 that may present a signal (e.g., WORD). The register 308 may have an input 324 that my receive the signal WORD and an input 328 that may receive a signal (e.g., WRITE_ENABLE). The register 312a may have an input 334 that may receive the signal CLK and an input 336 that may receive the signal CTRL. The register 312b may have an input 332 that may receive a signal (e.g., REC_CLK). The register 312n may have an input 330 that may receive the signal REC_CLK. The register 308 may have an input 329 that may receive the signal REC_CLOCK, an input 324 that may receive the signal WORD, an input 329 that may receive the signal REC_CLK and an output 326 that may present a signal (e.g., PARALLEL_DATA_BUS). The controller 301 may control and/or query the receiver 305. The controller 301 may control and/or query additional receivers (not shown).

An incoming serial bit stream may enter the high-speed serial receiver 305. A clock-data-recover unit (not shown) may generate the signal REC_CLK from the incoming serial bit stream. The deserializer 306 may convert the bit stream into parallel words. The parallel words may be stored in the register 308. The register 308 may be clocked by the signal REC_CLK. For the communication protocol used in system 100, the register 308 may be 16 bits wide. The signal PARALLEL_DATA_BUS may connect the register 308 to the controller 301 via the shared bus. The controller 301 may control the register 308 via the signal WRITE_ENABLE by asserting or deasserting the signal CTRL in accordance with the signal CLK. The signal CLK may operate at a much lower frequency than the signal REC_CLK. The synchronizer (or the registers 312b and 312n) may allow signals to cross clock domains. For example, the synchronization may allow a signal to pass from a clock domain CLK (e.g., the clock domain of the controller 340) to the clock domain REC_CLK (e.g., the clock domain of the signal WRITE_ENABLE).

To bit-align the incoming data stream into the receiver 305, the controller 301 may hunt for the character ALIGN by asserting the signal WRITE_ENABLE. The incoming 16-bit word may be sampled when the signal WRITE_ENABLE is asserted. When the signal WRITE_ENABLE is asserted, the 16 bits of incoming data may be held. In general, the aperture time of the circuit 300 (or sample-and-hold circuit) is 16 bit cycles. The controller 301 may execute a routine to compare the captured 16-bit word to 16 different bit-rotated versions of the character ALIGN.

Referring to FIG. 4, a circuit 350 illustrating a routine to compare a captured 16-bit word to a 16-bit rotated version in accordance with the present invention is shown. The circuit 350 generally comprises a 16-bit word 401, a number of bit shifted versions of the character ALIGN 402a-402n, and the register 308. The 16-bit word 401 may be captured by the register 308. The register 308 may sample and hold the 16-bit word. For example, the register 308 may sample and hold the value “1100 0001 1111 0001” as the 16-bit word 401. The value “1100 0001 1111 0001” may match both the one-bit-shifted version 402b and the two-bit-shifted version 402c of the character ALIGN. Although the don't-care characters in the character ALIGN may introduce ambiguity in bit alignment, there is normally enough information to distinguish between the character DOT and the character DASH. The controller 301 may determine a bit alignment offset to be either one or two.

Minimizing the probability of falsely recognizing any of the characters ALIGN, DOT, and/or DASH in the presence of bit errors may necessitate robust character recognition. The controller 301 may declare that a character has been successfully received after the controller 301 has recognized the character a number of times using the sample-and-hold method. For example, a bit error rate may assume a Poisson distribution of b, (or assume that each bit independently may be in error with a probability b). In one example, character ALIGN may be (“X0000X11 11X00X11”) as an example, having 16 bits (e.g., N=16) and 4 don't-care bits (e.g., D=4) as denoted by the four X's in “X0000X11 11X00X11”. The characters “10000111 11100011” and “00000011 11100111” both match the character ALIGN. Since there are 4 don't-care bits in the character ALIGN, there are 2ˆ4=16 characters that match the character ALIGN. To minimize false matching, the character ALIGN may be matched M times before confirming a match of the character ALIGN. The character ALIGN may be recognized with the following bitstream if M=3:

00000111 11100011 10000111 11100111 10000111 11100111<--- Bitstream

X0000X11 11X00X11 X0000X11 11X00X11 X0000X11 11X00x11<-- Match Target
Furthermore, a target character may include N bits, of which D bits may be don't care bits. The target character may be matched after the target character is recognized M times. The probability of falsely matching the target character may be defined as

$${( \frac{1}{2} )}^{M ( N - D )} - {( \frac{1 - b}{2} )}^{M ( N - D )} .$$

The more times the target character may be needed to appear consecutively for matching, the lower the probability of false matching.

Referring to FIG. 5, a diagram illustrating an exemplary bit-alignment state machine 400 for the receiver system 300 in accordance with the present invention is shown. The state machine generally comprises a state 402, a state 404a, a state 404b, a state 404c, a state 404n, a state 406a, a state 406b and a state 406n. The state 402 may be the hunt state. The states 404a-404n may be the confirm states. The states 406a-406n may be missed states.

In the state 402, the receiver 305 may sample and hold 16 bits of incoming data. The receiver 305 may match the 16-bit word against 16 different bit-shifted versions of the character ALIGN. Upon recognizing the character ALIGN with the least bit offset, the state machine 400 moves to the state 404a. In the state 404a, the receiver 305 may expect the character ALIGN with the same bit offset. If the receiver 305 does not recognize the character ALIGN, the state machine 400 may stay in the state 402. For each state 404a-404c (or CONFIRMᵢ), where i ranges from 1 to M−1, the state machine 400 samples and holds 16 bits of new data and matches the 16-bit word against the character ALIGN with the bit offset determined in the state 404a. If there is a match, then the state machine 400 advances from the state CONFIRMᵢ to the state CONFIRMᵢ₊₁. Otherwise, the state machine 400 moves back to the state 402. When the state machine 400 has reached the state 404n, the receiver system 300 may have successfully matched the character ALIGN M times from the incoming bit stream with the same bit offset as determined by the state 404a. The state machine 400 may stay in the state 404n until bit misalignment occurs, or when the receiver system 300 cannot match the characters ALIGN, DOT, and/or DASH from the incoming bit stream using the same bit offset. In such a case the state 400 moves to the state 406a. The state machine 400 may tolerate transient bit errors by allowing bit misalignment to occur for at most consecutively K characters. Next, the state machine 400 moves back to the state 402.

The characters ALIGN (‘@’), DOT (‘.’), DASH (‘-’), and ERROR (‘!’) may form a language and a simple protocol for the transceivers (or transmitters or receivers) to communicate with each other. Such a language may allow the protocol of the state machine 400 to run at a significantly below wire speed to interpret the language. An exemplary language may include a number of logic symbols. A first logic symbol (e.g., LOGIC0) may comprise a regular expression “@(.)+(−)+”, where “(c)+” denotes one or more occurrences of a character c, and c is a member of the character set {‘@’, ‘.’, ‘-’, ‘!’}. A string “@. . . .-----” may be interpreted as the LOGIC0 symbol. A second logic symbol (e.g., LOGIC1) may comprise the regular expression “@(-)+(.)+”. Therefore, the string “@----. .” may be interpreted as a LOGIC1 symbol. A third logic symbol (e.g., MISALIGNED) may comprise the character ‘(!)+’. Therefore, the string “!!!” may be interpreted as a MISALIGNED symbol. A fourth logic symbol (e.g., IDLE) may comprise the regular expression “(@)+”; thus, the string “@@@@@” may be interpreted as an IDLE symbol.

To disambiguate the grammar of the language, an ALIGN (‘@’) character K may bind more strongly to a DOT (‘.’) or a DASH (‘-’) symbol to the right of K than an additional ALIGN symbol to the left of K. Therefore, the string “5@@@@@@---. . .@@. .---@@” may be interpreted as a sequence of symbols comprising (i) the IDLE symbol which may include seven ALIGN characters followed by (ii) the LOGIC1 symbol which may include the string “@---. . . ” followed by (iii) the IDLE symbol which may include an ALIGN character followed by (iv) the LOGIC0 symbol which may include the string “@. .---” and followed by (v) an IDLE symbol which may include at least one ALIGN character.

The preferred embodiment of the present invention may use the links packet protocol (as described in connection with FIG. 1) that may need (i) a far-end transmitter to echo all of the characters that the far-end receiver has received and (ii) the far-end transmitter to transmit the a message (e.g., MISALIGNED) whenever the far-end bit-alignment state machine 400 is in the state 402. The link packet protocol may be packet based. Each packet that a transmitter transmits to a receiver may comprise (i) a header, (ii) a payload, and (iii) a checksum field. The header may comprise (i) a preamble, (ii) a start of frame delimiter and (iii) a payload length field. The preamble may comprise an IDLE symbol. The start-of-frame delimiter may comprise a LOGIC0 followed by the LOGIC1 and then followed by a LOGIC0. The LOGIC0 followed by the LOGIC1 and followed by the LOGIC0 may be optionally punctuated by IDLE symbols, or the sequence: <LOGIC0, (IDLE)?, LOGIC1, (IDLE)?, LOGIC0, (IDLE)?>, where “(s)?” may denote zero or one symbol s.

In one example, the payload length field may comprise 10 binary symbols. A binary symbol may be either a LOGIC1 or a LOGIC0 symbol. Each adjacent pair of binary symbols may optionally be punctuated by an IDLE symbol, or “((LOGIC0|LOGIC1) (IDLE)?)¹⁰”, where “(s)ⁿ” may denote the symbol s repeating n times consecutively and “(s₁|S₂)” may denote the occurrence of either the symbol s₁ or the symbol s₂ but not both. The 10 binary symbols of the payload length field may denote the length of the payload in bytes. In one example, a payload comprising 800 bytes may be represented by the symbol sequence <LOGIC1, LOGIC1, IDLE, LOGIC0, LOGIC0, LOGIC1, IDLE, (LOGIC0)⁵>. The symbol sequence may represent the number 800 and the binary number 1100100000. In one example, the payload of the packet may comprise P binary symbols, where P may be eight times the number represented by the payload length field in the packet header, or “((LOGIC0|LOGIC1) (IDLE)?)^{p}”. In one example, the checksum field of the packet may comprise 32 binary symbols. The 32 binary symbols of the checksum field may represent a 32-bit checksum of the header and the payload, or “((LOGIC0|LOGIC1) (IDLE)?)³²”,

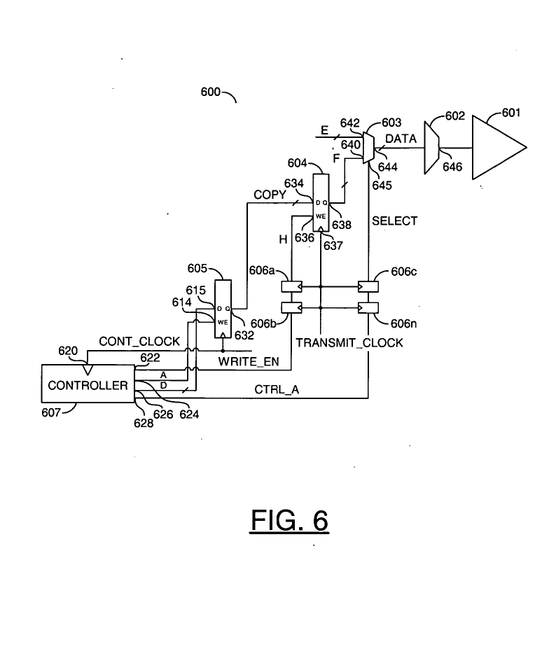

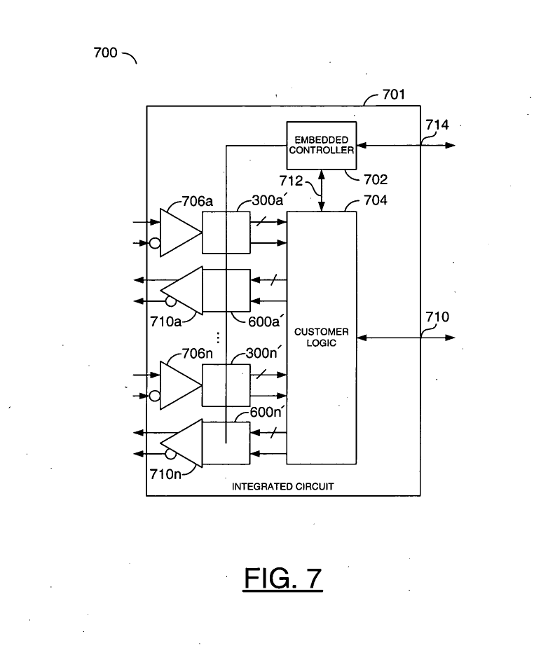

Referring to FIG. 6, a detailed diagram of a transmitter system 600 in accordance with the present invention is shown. The system 600 generally comprises, a block (or circuit) 601, a block (or circuit) 602, a block (or circuit) 603, a block (or circuit) 604, a block (or circuit) 605, a number of blocks (or circuits) 606a-606n and a block (or circuit) 607. The circuit 601 may be implemented as a high-speed serial transmitter 601. The circuit 602 may be implemented as a serializer. The circuit 603 may be implemented as a multiplexer. The circuit 604 may be implemented as a register. The circuit 605 may be implemented as a register. The circuits 606a-606n may be implemented as registers. The registers 606a and 606b may be implemented as a synchronizer. The registers 606c and 606n may be implemented as a synchronizer. The circuit 607 may be implemented as a controller. The transmitter system 600 may transmit the characters ALIGN, DOT, DASH, and/or ERROR from the controller 607. The controller 607 may have an input 620 that may receive a signal (e.g., CONT_CLOCK). The controller 607 may have an output 622 that may present a signal (e.g., WRITE_EN), an output 624 that may present a signal (e.g., A), and an output 626 that may present a signal (e.g., D), and an output 628 that may present a signal (e.g., CTRL_A). The multiplexer 603 may have an input 640 that may receive a signal (e.g., F), an input 642 that may receive an signal (e.g., E), an input 645 that may receive a signal (e.g., SELECT) and an output 644 that may present a signal (e.g., DATA). The register 605 may have an input 614 that may receive the signal A, an input 615 that may receive the signal D, an input 632 that may receive the signal CONT-CLOCK, and an output 632 that may present a signal (e.g., COPY). The register 604 may have an input 634 that may receive the signal COPY, an input 636 that may receive the signal (e.g., H), an input 637 that may receive a signal (e.g., TRANSMIT_CLOCK), and an output 638 that may present a signal F. The controller 607 may control and/or query one or more transmitters.

The circuit 600 may implement the controller 607 used to generate the output characters through the high-speed serial transmitter 601. The transmitter system 600 may implement two clock domains (e.g., a CONT_CLOCK and a TRANSMIT_CLOCK). During normal data transmission, the multiplexer 603 may connect data traffic between the signal E to the signal DATA for the serializer 602. The serializer 602 may feed the high-speed serial transmitter 601′. When the link packet protocol is active, the controller 607 may route the signal F to the transmitter 601 by configuring the multiplexer 603 in response to the signal TRANSMIT_CLOCK. The registers 604 and 605 may be 16-bit registers. The register 605 may be clocked by the signal CONT_CLOCK. The register 604 may be clocked by the signal TRANSMIT_CLOCK. As the controller 607 and the transmitter 601 may be in different clock domains, the controller 607 may store a new character in the register 605. The register 605 may be in the same clock domain as the controller 301. The register 605 may copy the character to the register 604 when the signal WRITE_EN is asserted by the registers 606a-606b (or the synchronizer). The registers 606a and 606b form a synchronizer to synchronize the signal WRITE_EN. The registers 606c and 606n form a synchronizer to synchronize the signal CTRL_A. The register 605 may be in the same clock domain as the controller 607.

Referring to FIG. 7, an exemplary application-specific integrated circuit in accordance with the present invention is shown. The circuit 700 generally comprises an embedded controller 702, customer logic 704, a number of receivers 706a-706n, a number, of receiver systems 300a′-300n′, a number of transmitter systems 600a′-600n′, a number of transmitters 710a-710n, a host bus 712, a host bus 714 and a host bus 716. Each receiver system 300a′-300n′ may include all circuits of the receiver system 300 except for the controller 301. Each transmitter system 600a′-600n′ may include all circuits of the transmitter system 600 except for the controller 601. The customer logic 704 may include registers (not shown). The host bus 712 may couple the controller 702 to the customer logic 704. The host bus 714 may allow the controller 702 to access devices external to the integrated circuit 701. The host bus 714 may allow devices external to the integrated circuit 701 to access the controller 702 and registers in the customer logic 704. Generally, system software may communicate with the embedded controller 702 via the host bus 714. For example, system software may assign a particular embedded controller to be a master controller. The host bus 712 and the host bus 710 may allow the controller 702 to access external devices coupled to the customer logic 704. The controller 702 may be implemented as a master controller. The controller 702 may be implemented as a slave controller. The controller 702 (e.g., whether the controller 702 is a master controller or a slave controller) may control and query the customer logic via the host bus 712.

The exemplary link optimization protocol implemented by the circuit 700 may enable the embedded controller 702 to run at a below wire speed where multiple transceivers may share the same embedded controller.

Additional embodiments may include that the controller may implement the protocol state machine described in connection with FIG. 5 as a hard-wired state machine or as a processor executing software or firmware.

The present invention may (i) send the first logic symbol LOGIC0 and the second logic symbol LOGIC1 reliably over an unoptimized link at a lower speed with an error-tolerant protocol and (ii) define commands and responses based on binary codewords made from the first logic symbol LOGIC0 and the second logic symbol LOGIC1. The present invention may use an embedded controller that runs firmware without implementing hard-wired state machines. The embedded controller may run firmware to eliminate thousands of serdes (or serializers or deserializer) across a backplane to talk to each other in order to tune serdes parameters for optimizing serial links.

The present invention generally provides a communication system having multiple integrated circuits and each multiple integrated circuit includes an embedded controller. Each integrated circuit in a communication system generally includes differential serial transceivers and/or single-ended transceivers. For a bidirectional data link across two integrated circuits (e.g., a master and a slave) with transceivers, the controller in the master integrated circuit may (i) set the transmitter parameters and (ii) signal in-band to the slave receiver to set parameters for the slave receiver. The transmitter on the master integrated circuit may (i) send data signals to the slave receiver for signal quality measurements and (ii) collect a signal quality report from the slave receiver via an opposite link. Signal quality reporting may include bit error rate measurements, signal eye width, and eye height as measured inside the receiver after receive equalization. System software may swap the roles between a master controller and a slave control when necessary. The present invention generally provides a robust link optimization communication protocol. The robust link optimization communication may be robust as transceivers communicate with each other reliably across unoptimized links. The present invention may be flexible and incur little design overhead for a transceiver. In accordance with one embodiment of the invention, a subset of the integrated circuits with transceivers in a communication system comprise an embedded controller.

The present invention provides a system for optimizing transceiver parameters. The system enables networking with integrated circuits having high-speed receivers and transmitters to automatically characterize communication links. The present invention may need minimal system-level software intervention to enable the integrated circuits to communicate amongst themselves to fine-tune transceiver parameters for link optimization. The integrated circuits may use a common robust protocol to communicate with each other. The communication protocol may reduce system software development effort.

The present invention may allow a transceiver vendor to provide link optimization software and hardware interface for transceivers. The transceivers may be simpler to integrate into a system if link optimization was provided on software and a hardware interface was provided. Instead of using system-level resources, such as an on-board microprocessor, the transceiver vendor may supply a controller, in the form of a state machine or a programmable microcontroller to implement link optimization as set forth by the present invention. To the system designer (transceiver user), the link optimization process may be a transparent process.

The function performed by the state machine of FIG. 5 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMs, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. An apparatus comprising:
at least two controllers, each controller configured to control one or more transmitters and one or more receivers in response to a one or more control state signals; and
one or more links configured to allow communication between said controllers to automatically perform link characterization of said one or more links with a link packet protocol.

2. The apparatus according to claim 1, wherein a first one or more of said transmitters are coupled to a second one or more of said receivers via said links.

3. The apparatus according to claim 2, wherein said transmitters and said receivers each comprise a plurality of link optimization parameters.

4. The apparatus according to claim 3, wherein said link optimization parameters comprise:
a pre-emphasis parameter in each of said first transmitters and a second one or more of said transmitters to increase high-frequency components;
a first decision feedback equalization parameter in a first one or more of said receivers and a second one or more of receivers to (i) form a first adaptive filter in each receiver and (ii) recover signals in the presence of cross talk; and
a second decision feedback equalization parameter in each of said first transmitters, said second transmitters, said first receivers, and said second receivers to (i) form a second adaptive filter in each of said first transmitters, said second transmitters, said first receivers and said second receivers and (ii) recover signals in the presence of cross talk.

5. The apparatus according to claim 4, wherein (i) said first transmitters are configured to present a predetermined bitstream to said second receivers across said links and (ii) said second receivers are configured to measure bit errors on said bitstream to ensure the sufficiency of said link optimization parameters.

6. The apparatus according to claim 5, wherein said bitstream comprises at least one of (i) a pseudo-random bitstream (PRBS) and (ii) predetermined patterns.

7. The apparatus according to claim 5, wherein each of said second receivers are configured to measure a signal voltage amplitude to ensure the sufficiency of said link optimization parameters.

8. The apparatus according to claim 5, wherein said second receivers are configured to measure a signal jitter to ensure the sufficiency of said link optimization parameters.

9. The apparatus according to claim 4, wherein (i) said first transmitters are configured to present a predetermined bitstream to said second receivers across said links and (ii) each of said second receivers are configured to (a) measure bit errors on said bitstream and (b) measure a signal jitter to ensure the sufficiency of said link optimization parameters.

10. The apparatus according to claim 4, wherein each of said second receivers are configured to measure (i) a signal voltage amplitude and (ii) a signal jitter to ensure the sufficiency of said link optimization parameters.

11. The apparatus according to claim 1, wherein (i) said first controller, a first one or more of said transmitters and a first one or more of said receivers are positioned on a first integrated circuit and (ii) said second controller, a second one or more of said transmitters and a second one or more of said receivers are positioned on a second integrated circuit.

12. The apparatus according to claim 1, wherein said first controller is configured to control and query one or more of said transmitters and one or more of said receivers as a master controller.

13. The apparatus according to claim 1, wherein said second controller is configured to control and query one or more of said transmitters and one or more of said receivers as a master controller.

14. The apparatus according to claim 1, wherein said two or more controllers operate at a substantially lower bit rate than the bit rate across said one or more links.

15. The apparatus according to claim 1, wherein said link packet protocol comprises one or more characters which forms commands to (i) allow a first of said controllers to control and query a first one of said transmitters and a first one of said receiver, (ii) allow a second of said controllers to control and query a second of said transmitters and a second of said receivers and (iii) provide (a) fault-tolerance and (b) protocol extensibility by encapsulating said commands into one or more packets.

16. The apparatus according to claim 15, wherein each character is DC balanced.

17. The apparatus according to claim 15, wherein a first of said receivers is configured to (i) hunt for said one or more characters by sampling and holding each of said one or more characters and (ii) compare the held character to a plurality of bit shifted versions of the character.

18. The apparatus according to claim 1, further comprising:
a customer logic coupled to (i) said first controller via a host bus, (ii) a first of said transmitters, and (iii) a first of said receivers, wherein a first of said controllers controls and queries said customer logic with said host bus.

19. An apparatus comprising:
means for controlling one or more first transmitters and one or more first receivers in response to a first control state signal;
means for controlling one or more second transmitters and one or more second receivers in response to a second control state signal; and
means for linking communication between said means for controlling said one or more first transmitters and means for controlling said one or more second transmitters to automatically characterize said means for linking with a link packet protocol.

20. A method for link optimization between controllers comprising the steps of:
(A) controlling one or more first transmitters and one or more first receivers with a first controller in response to a first control state signal;
(B) controlling one or more second transmitters and one or more second receivers with a second controller in response to a second control state signal; and
(C) allowing communication between said first controller and said second controller to automatically characterize one or more links with a link packet protocol.
